(19) United States
(12) Patent Application Publication
(10) Pub. No.: US 2014/0063845 A1
(43) Pub. Date: Mar. 6, 2014

(54) LIGHT-GUIDING PLATE AND PLANE ILLUMINATION APPARATUS THEREWITH

(71) Applicant: WINTEK CORPORATION, Taichung City (TW)

(72) Inventors: Zhi-Ting Ye, Miaoli County (TW); Ming-Chuan Lin, Taichung City (TW); Chia-Hung Pan, Taichung City (TW); Hsiu-Ping Lee, Taichung City (TW)

(73) Assignee: WINTEK CORPORATION, Taichung City (TW)

(21) Appl. No.: 13/895,365

(22) Filed: May 16, 2013

(30) Foreign Application Priority Data
Aug. 28, 2012 (TW) 101131202

(51) Int. Cl. F21V 8/00

(52) U.S. Cl. CPC G02B 6/0035; G02B 6/0018; G02B 6/0013; G02B 6/003
USPC 362/609; 362/623; 362/621; 362/613; 362/608

(57) ABSTRACT

A light-guiding plate and a plane illumination apparatus therewith are disclosed. The plane illumination apparatus includes the light-guiding plate and at least one light-emitting source. The light-guiding plate includes a light incident surface, a first surface opposite to the light incident surface, a second surface between the light incident surface and the first surface, and a light emitting surface opposite to the second surface. The second surface is coated with diffuse reflection layer. The first surface gradually extends substantially toward the light incident surface from its one side near to the second surface to the other side near to the light emitting surface. The light-emitting source is disposed corresponding to the light incident surface for providing a light beam.

### BACKGROUND OF THE INVENTION

1. Field of the Invention

The invention relates to a light-guiding plate and illumination apparatus, and especially relates to a light-guiding plate for illumination and a plane illumination apparatus therewith.

2. Description of the Prior Art

Conventional plane lamps using light-guiding plates are usually based on a design that light-emitting sources are disposed at one side or two opposite sides of a light-guiding plate. The light-emitting sources provide light beams, which enter the light-guiding plate and emit out the light-guiding plate from a light emitting surface of the light-guiding plate for illumination. To improve the directivity of the light beams, a light-guiding structure such as dots are usually disposed on a side of the light-guiding plate opposite to the light emitting surface for guiding the light beams toward the light emitting surface. In addition, to increase the light emitting efficiency, a reflection sheet is usually disposed outside the side of light-guiding plate opposite to the light emitting surface, such that a portion of the light beams leaking out from the side of light-guiding plate opposite to the light emitting surface can be reflected by the reflection sheet to enter the light-guiding plate again and emit out the light-guiding plate from the light emitting surface for increasing the light emitting efficiency. In addition, regarding some designs for the light-guiding plate, a reflection structure is disposed at a side of the light-guiding plate opposite to the light-emitting source for preventing the light beam reaching here from directly leaking out and for guiding the light beam back to the light-guiding plate to increase the light emitting efficiency. However, the side surface opposite to the light incident surface of such light-guiding plate is usually a plane perpendicular to an optical axis, so that paraxial light beams with high energy reach here to be reflected back to the light incident surface, leading to a lower usage of the paraxial light beams and a distinct bright region at the area close to the light incident surface of the plane lamps. Further, the light beams reflected by the reflection structure disposed at the side opposite to the light incident surface to emit out of the light-guiding plate are usually constrained within a fringe area of the light emitting surface, so that the plane lamp produces an illumination area with bright edge. Furthermore, for general use requirements, it is required that plane lamps can provide an illumination area with uniform brightness. Also for requirements for environment protection and low cost, there is a need for a light-guiding plate, which has an improved usage and uniformity of light and is made by a simplified manufacturing process, and a plane illumination apparatus therewith.

### SUMMARY OF THE INVENTION

An objective of the invention is to provide a light-guiding plate, which uses a reflection surface opposite to a light incident surface thereof to reflect light beams for improving the light emitting efficiency therefor and also for improving illumination distribution by a few times reflection. Further, the light-guiding plate can have a diffuse reflection layer on the reflection surface for solving the problem in the prior art that paraxial light beams cannot be used efficiently.

The light-guiding plate of the invention is applied to an illumination apparatus. The illumination apparatus includes at least one light-emitting source and the light-guiding plate. The light-emitting source provides alight beam. The light-guiding plate includes a light incident surface, a light emitting surface, a first surface, and a second surface. The first surface is opposite to the light incident surface. The light emitting surface is opposite to the second surface. The second surface is located between the light incident surface and the first surface and coated with a second diffuse reflection layer. The first surface extends substantially toward the light incident surface from a first side of the first surface close to the second surface to a second side of the first surface close to the light emitting surface. Therein, a first portion of the light beam is diffusely reflected by the second surface and then passes through the light emitting surface out of the light-guiding plate, so as to increase the light emitting efficiency and distribution uniformity of the light beam. In addition, the first surface can deflect a paraxial light beam from the light-emitting source toward the light emitting surface and totally reflect a part of the light beam toward the second surface to be diffusely reflected by the second surface toward the light emitting surface, so as to increasing the illuminance of the illumination apparatus.

Further, a symbol W is assumed to be a width of a projection area of the first surface onto the second surface. A symbol D is assumed to be a projection distance of the second side of the first surface to the second surface. The light-guiding plate further satisfies the following condition: 0<W/D<0.6, so as to adjust the surface shape of the first surface for increasing the efficiency of the light beam emitting out the light emitting surface. Furthermore, the first surface of the light-guiding plate is coated with a first diffuse reflection layer. A second portion of the light beam entering the light-guiding plate from the light incident surface is diffusely reflected by the first surface and the second surface in order and then passes through the light emitting surface out of the light-guiding plate. Thereby, the light beams, whose traveling direction is parallel to the optical axis of the light-emitting source or even forms a small included angle with the optical axis (i.e. paraxial light beams), can be reflected by the first surface and the second surface in order and then emit out of the light-guiding plate, so that the paraxial light beams with high energy can be guided out efficiently so as to increase the light emitting efficiency of the light-guiding plate. Furthermore, because a portion of the light beam reflected by the first surface does not directly pass through the light emitting surface but is reflected by the second surface and then emits out the light-guiding plate, the portion of the light beam emitting out the light-guiding plate is not likely to concentrate on a fringe of an illumination area.

Further, by designing the optical surface shape of the first surface, the portion of the light beam is reflected to be scattered toward a middle portion of the second surface, so as to further improve the illumination uniformity or avoid an existence of a distinct bright band at the middle portion of the illumination apparatus, and also efficiently improve the problem that the light-guiding plate in the prior art makes a portion of light beams concentrate at the fringe thereof and the light beams are not efficiently used. In some embodiment, the first surface can be a curved surface, a plurality of successive inclined planes or an inclined plane. Therein, an included angle between the normal direction of the curved surface or the successive inclined plane and the direction of the optical axis of the light-emitting source monotonously increases from the first side to the second side of the first surface.

Another objective of the invention is to provide a plane illumination apparatus equipped with the light-guiding plate of the invention. Therefore, the plane illumination apparatus has a higher light emitting efficiency for enhancing the illumination efficiency thereof.

A plane illumination apparatus of the invention includes a light-guiding plate and at least one light-emitting source. The light-guiding plate includes a light incident surface, a light emitting surface, a first surface, and a second surface. The first surface is opposite to the light incident surface. The light emitting surface is opposite to the second surface. The second surface is located between the light incident surface and the first surface and coated with a second diffuse reflection layer. The first surface extends substantially toward the light incident surface from a first side of the first surface close to the second surface to a second side of the first surface close to the light emitting surface. The at least one light-emitting source is disposed corresponding to the light incident surface and provides a light beam. The light beam enters the light-guiding plate from the light incident surface. Each light-emitting source has an optical axis. Therein, a first portion of the light beam is diffusely reflected by the second surface and then passes through the light emitting surface out of the light-guiding plate, so as to increasing the light emitting efficiency and the illumination uniformity of the illumination apparatus.

Further, each light-emitting source of the plane illumination apparatus can has an optical lens for distributing the light beam. A reflection part can be disposed at an outer periphery of the light-emitting source. The light incident surface of the light-guiding plate has at least one recess corresponding to a profile of the optical lens for covering the at least one light-emitting source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded view of a plane illumination apparatus of a preferred embodiment according to the invention.

FIG. 2 is a sectional view of the plane illumination apparatus in FIG. 1 according to an embodiment.

FIG. 3 is a sectional view of the plane illumination apparatus in FIG. 1 according to another embodiment.

FIG. 4 is an enlarged view of a light-guiding plate in FIG. 1 at a first surface thereof.

FIG. 5 is an enlarged view of a part of a light-guiding plate according to another embodiment.

FIG. 6 is an enlarged view of a part of a light-guiding plate according to another embodiment.

FIG. 7 is a sectional view of a plane illumination apparatus according to another embodiment.

FIG. 8 is a sectional view of a plane illumination apparatus according to another embodiment.

FIG. 9 is a sectional diagram illustrating the configuration of a light-guiding plate and a light-emitting source 66 according to another embodiment.

FIG. 10 is a sectional diagram illustrating the configuration of a light-guiding plate and a light-emitting source 66 according to another embodiment.

### DETAILED DESCRIPTION

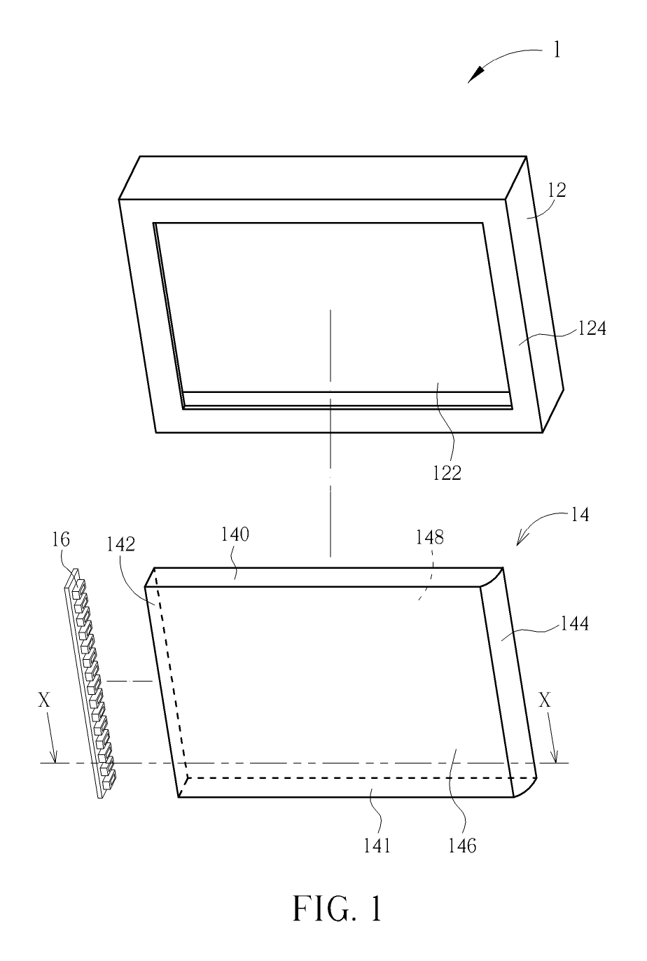

Please refer to FIG. 1, which is an exploded view of a plane illumination apparatus 1 of a preferred embodiment according to the invention. The plane illumination apparatus 1 includes a casing 12, a light-guiding plate 14, a plurality of light-emitting sources 16, and other required electronic components (such as control module, transformer and so on). For simple illustration, the above electronic components are not shown in the figure and will not be described in the following. In addition, in practice, the actual structure of the casing 12 depends on an actual product of different needs and is not limited to the configuration of the embodiment. In the embodiment, the light-emitting sources 16 are realized by a light-emitting diode (LED) bar, but the invention is not limited thereto. The casing 12 accommodates the light-guiding plate 14, the light-emitting source 16, and the other required electronic components. The casing 12 has a light emitting window 122 for exposing the light-guiding plate 14.

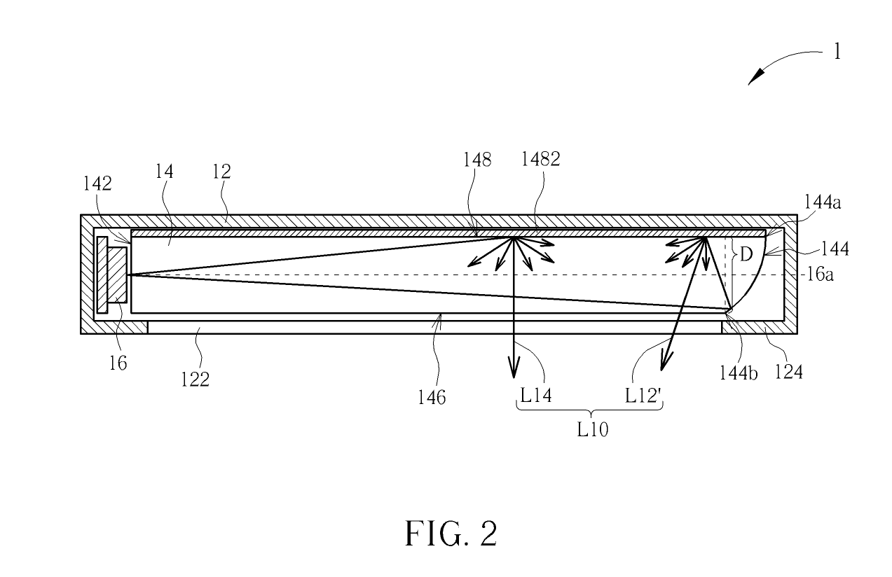

Please refer to FIG. 2, which is a sectional view of the plane illumination apparatus 1 of a first embodiment; the cutting position therefor is referred to the line X-X in FIG. 1. Therein, for simple illustration, the light-guiding plate 14 is shown without hatching lines, which is also applied to the following figures. The light-guiding plate 14 includes a first side surface 140, a second side surface 141, a light incident surface 142, a first surface 144, a light emitting surface 146, and a second surface 148. The first surface 144 is opposite to the light incident surface 142. The light emitting surface 146 is opposite to the second surface 148. In the plane illumination apparatus 1, the light emitting surface 146 can be disposed corresponding to the light emitting window 122 for exposing the light emitting surface 146; the light-emitting source 16 is disposed corresponding to the light incident surface 142 and provides light beams L10. The light beam L10 enters the light-guiding plate 14 through the light incident surface 142. Each light-emitting source 16 has an optical axis 16a. The second surface 148 is located between the light incident surface 142 and the first surface 144 and coated with a second diffuse reflection layer 1482. The second diffuse reflection layer 1482 can be but not limited to ink or component including a base material and light diffusion particles. The diffuse reflection layer of the present disclosure can be formed by but not limited to printing or bi-injection with the light-guiding plate. The substrate can be made of Polymethylmethacrylate (PMMA) or Polycarbonate (PC) for example. The light diffusion particle can be made of TiO₂, SiO₂ or combination thereof for example. The second diffuse reflection layer 1482 will diffusely reflect a first portion L14 of the light beam L10 at the interface so as to destroy total internal reflection for assisting the light-guiding plate 14 to guide the light beam to the light emitting surface 146 and thereby emits out, which increases the illuminance and the illumination uniformity of the plane illumination apparatus 1. Therein, for simple illustration, the thickness of the second diffuse reflection layer 1482 is exaggeratedly shown in FIG. 2. In addition, in some embodiment, the first side surface 140 and the second side surface 141 can also be coated with a diffuse reflection layer respectively. The first surface 144 extends substantially toward the light incident surface 142 from a first side 144a of the first surface 144 close to the second surface 148 to a second side 144b of the first surface 144 close to the light emitting surface 146. Thereby, as shown in FIG. 2, the first surface 144 can deflect paraxial light beams from the light-emitting source 16 toward the light emitting surface 146. A part of light beam L12′ therein is totally reflected by the first surface 144 toward the second surface 148 and then is diffusely reflected by the second surface 148 toward the light emitting surface 146, so as to increasing the illuminance of the plane illumination apparatus 1.

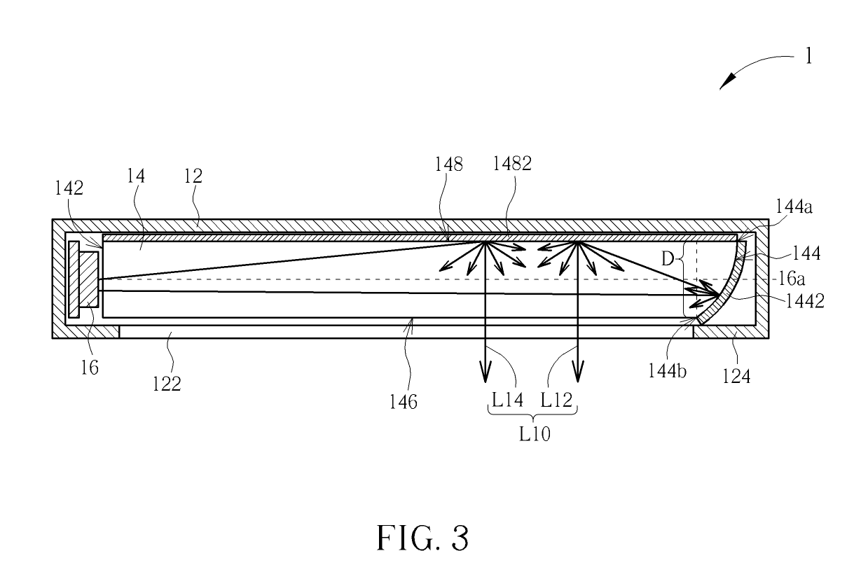

Please refer to FIG. 3, which is a sectional view of the plane illumination apparatus 1 of a second embodiment; the cutting position therefor is referred to the line X-X in FIG. 1. Compared with the first embodiment, the first surface 144 of the light-guiding plate 14 of the embodiment is further coated with a first diffuse reflection layer 1442. The first diffuse reflection layer 1442 can be but not limited to ink or component including a base material and light diffusion particles. The first diffuse reflection layer 1442 and the second diffuse reflection layer 1482 can be made of the same or different material. Thereby, paraxial light beams can be diffusely reflected by the first surface 144 and the second surface 148 in order and then emit out of the light-guiding plate 14, so that the paraxial light beams with high energy can be efficiently guided out the light-guiding plate 14 so as to improve the light emitting efficiency of the light-guiding plate 14. As shown in FIG. 3, after the light beam L10 enters the light-guiding plate 14, a first portion L14 of the light beam L10 is diffusely reflected by the second surface 148 and then passes through the light emitting surface 146 out of the light-guiding plate 14. A second portion L12 of the light beam L10 is diffusely reflected by the first surface 144 and the second surface 148 in order and then passes through the light emitting surface 146 out of the light-guiding plate 14. After emitting out of the light-guiding plate 14 through the light emitting surface 146, the light beam L10 passes through the light emitting window 122 for illumination. The first portion L14 and the second portion L12 of the light beam L10 are shown by solid lines with arrow in FIG. 2 and FIG. 3.

Further, the second portion L12 of the light beam L10 has the following feature: the tangent value of the included angle between the traveling direction of the second portion L12 of the light beam L10 and the direction of the optical axis 16a is smaller than a half of the projection distance D of the second side 144b of the first surface 144 onto the second surface 148 divided by the minimum distance between the light incident surface 142 and the first surface 144. That is, the second portion L12 of the light beam L10 has a larger light intensity and is reflected by the first surface 144 and the second surface 148 in order and then passes through the light emitting surface 146 out of the light-guiding plate 14. Therefore, the problem of inefficient use of the paraxial light beams in the prior art is overcome herein. In the embodiment, the minimum distance is the distance from the second side 144b of the first surface 144 along the light emitting surface 146 to the light incident surface 142. For some applications, when the minimum distance is much larger than the projection distance D, difference between distances from any place of the first surface 144 to the light incident surface 142 is small. In such case, for the above tangent value, the minimum distance therein can be replaced directly with a nominal distance from the first surface 144 to the light incident surface 142, such as specification dimensions of product.

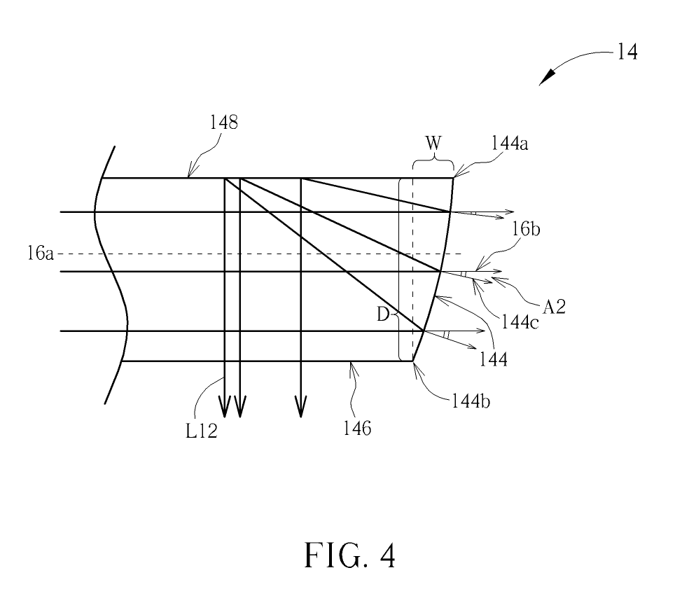

Please also refer to FIG. 4. FIG. 4 is an enlarged view of the light-guiding plate 14 in FIG. 1 at the first surface 144; therein, for simple illustration, the first diffuse reflection layer 1442 and the second diffuse reflection layer 1482 are not shown in FIG. 4. When the first surface 144 is coated with the first diffuse reflection layer 1442, the geometric profile (i.e. the optical surface shape) of the first surface 144 determines the reflection angle of the second portion L12 of the light beam L10 at the first surface 144. In other hand, when the first surface 144 is not coated with the diffuse reflection layer 1442, the geometric profile of the first surface 144 determines the total reflection angle or refraction angle of the light beam L10 at the first surface 144. That is, the geometric profile of the first surface 144 determines the traveling direction of the light beam L10 away from the first surface 144. In the embodiment, the first surface 144 is a curved surface. The included angle A2 between the normal direction 144c of the first surface 144 and the direction 16b of the optical axis 16a monotonously increases from the first side 144a to the second side 144b of the first surface 144, so that after reflected by the first surface 144, the second portion L12 of the light beam L10 is not likely to be concentrated toward the second surface 148 to avoid an existence of a distinct bright area due to excessively concentrating. Alternatively, if the first surface 144 is not coated with the first diffuse reflection layer 1442, the curved surface of the first surface 144 can be designed to be capable of making light beams away from the first surface 144 be properly distributed, so as to avoid an existence of a distinct bright area due to excessively concentrating. In other some embodiments, the first surface 144 can be a spherical surface with a curvature radius of 40.89 mm, or a spherical or aspherical surface with a curvature radius ranging within 1˜1000 mm. The included angle A2 monotonously increases from the first side 144a to the second side 144b of the first surface 144. Further, by a proper design for the curved surface of the first surface 144, the distribution of the positions of the second portion L12 of the light beam L10 reflected to the second surface 148 can be controlled, i.e. to indirectly adjust the illumination distribution of the plane illumination apparatus 1. For example, the first surface 144 can diffusely reflect the second portion L12 of the light beam L10 toward the middle portion of the second surface 148. In a conventional light-guiding plate directing light sources disposed at sides thereof, the illumination redistributed by the conventional light-guiding plate usually has a lower illuminance at the central portion; on the contrary, the plane illumination apparatus 1 can compensate illuminance at the middle portion thereof based on the diffuse reflection by the first surface 144, so as to improve the illumination efficiency and uniformity for satisfying common requirements.

In some embodiments, for further improvement in the efficiency of the light beam L10 passing through the light emitting surface 146, the light-guiding plate 14 can further satisfy the following condition (1): 0<W/D<0.6; therein, W is a width of a projection area of the first surface 144 onto the second surface 148, and D is a projection distance from the second side 144b of the first surface 144 to the second surface 148. Furthermore, the above condition also assists in constraining the second side 144b of the first surface 144 from excessively extending toward the light incident surface 142 to avoid the area of the light emitting surface 146 from being too smaller and to optimize the light emitting efficiency of the plane illumination apparatus 1. For example, in one embodiment, the first surface 144 can be a spherical surface with a curvature radius of 36.34 mm, and W/D=0.48; however, the invention is not limited thereto. In addition, if the first surface 144 of the light-guiding plate 14 is coated with the first diffuse reflection layer 1442 and meets the condition (1), the light beam L10 can further be avoided from being reflected by the second surface 148 back to the first surface 144 after reflected by the first surface 144, leading that it is difficult for the light beam L10 to emit out of the light-guiding plate 14.

It is added that, the above tangent value of the included angle between the traveling direction of the second portion L12 of the light beam L10 and the direction of the optical axis 16a and the value of W/D are shown by numerals just for examples for showing the efficacy of the invention, but the invention is not limited thereto. In addition, in the embodiment, the casing 12 includes a border portion 124 surrounding to form the light emitting window 122 and covering the light-emitting source 16 and the first surface 144, so that the appearance of the plane illumination apparatus 1 shows simple.

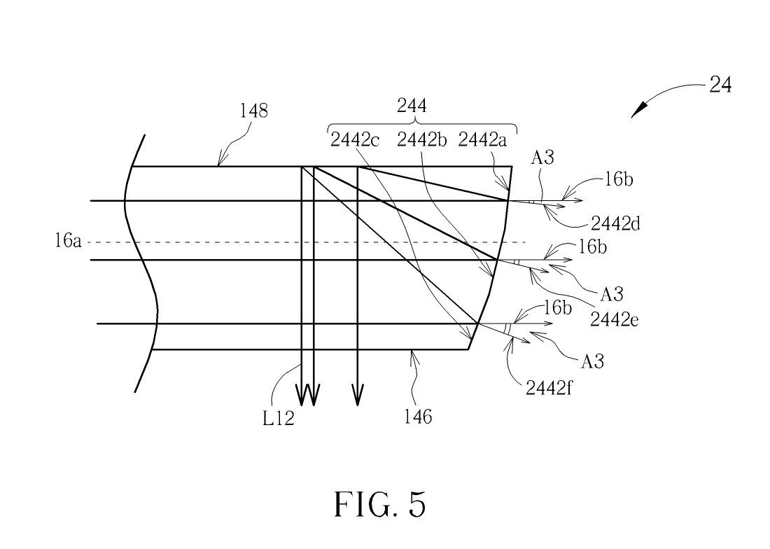

In the above embodiment, the first surface 144 is realized by a curved surface with continuously varying normal direction, but the invention is not limited thereto. Please refer to FIG. 5, which is an enlarged view of a part of a light-guiding plate 24 according to another embodiment. In the embodiment, the light-guiding plate 24 is structurally similar to the light-guiding plate 14, so the light-guiding plate 24 still uses the component notations of the light-guiding plate 14. The relevant descriptions of the light-guiding plate 14 being applicable to the light-guiding plate 24 will not be described repeatedly herein. The main difference between the light-guiding plate 24 and the light-guiding plate 14 is that the first surface 244 of the light-guiding plate 24 includes three successive inclined planes 2442a, 2442b and 2442c. The included angles A3 between the normal directions 2442d, 2442e and 2442f of the inclined planes 2442a, 2442b and 2442c and the direction 16b of the optical axis 16a respectively monotonously increase from the first side 244a to the second side 244b of the first surface 244. In the embodiment, although the normal directions 2442d, 2442e and 2442f of the first surface 244 vary discretely, the improvement in the usage efficiency of the light beam L10 and the light emitting efficiency of the light-guiding plate 24 also can be obtained. It is added that in the embodiment, the included angle A3 between the normal direction 2442d and the direction 16b of the optical axis 16a can be limited to be from 1° to 4°; the included angle A3 between the normal direction 2442e and the direction 16b of the optical axis 16a can be limited to be from 3° to 6°; the included angle A3 between the normal direction 2442f and the direction 16b of the optical axis 16a can be limited to be from 5° to 8°. Therein, the included angles A3 still monotonously increase from the first side 144a to the second side 144b of the first surface 144. For example, the variation of the included angles A3 from the first side 144a to the second side 144b of the first surface 144 is 2°-4°-6°. In such case, under the condition that the first surface 144 is coated with the first diffuse reflection layer 1442, the light emitting efficiency of the light-guiding plate 24 of the invention is improved to 75%; on the contrary, the light emitting efficiency of a conventional light-guiding plate is 59.6%.

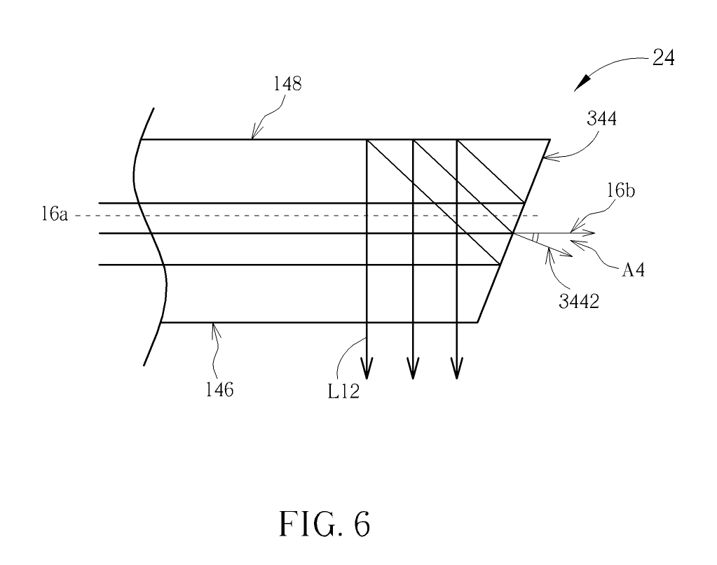

Please refer to FIG. 6, which is an enlarged view of a part of a light-guiding plate 34 according to another embodiment. In the embodiment, the light-guiding plate 34 is structurally similar to the light-guiding plate 14, so the light-guiding plate 34 still uses the component notations of the light-guiding plate 14. The relevant descriptions of the light-guiding plate 14 being applicable to the light-guiding plate 34 will not be described repeatedly herein. The main difference between the light-guiding plate 34 and the light-guiding plate 14 is that the first surface 344 of the light-guiding plate 34 is an inclined plane. In the embodiment, the first surface 344 has only one normal direction 3442. An included angle A4 between the normal direction 3442 and the direction 16b of the optical axis 16a is a definite value, 4° for example, which also can obtain the improvement in the usage efficiency of the light beam L10 and the light emitting efficiency of the light-guiding plate 34. It is added that for simple illustration, the included angles A2, A3 and A4 of the first surfaces 144, 244 and 344 respectively are exaggeratedly shown in FIGS. 4 through 6, and do not indicate the profile and size ratio of an actual production.

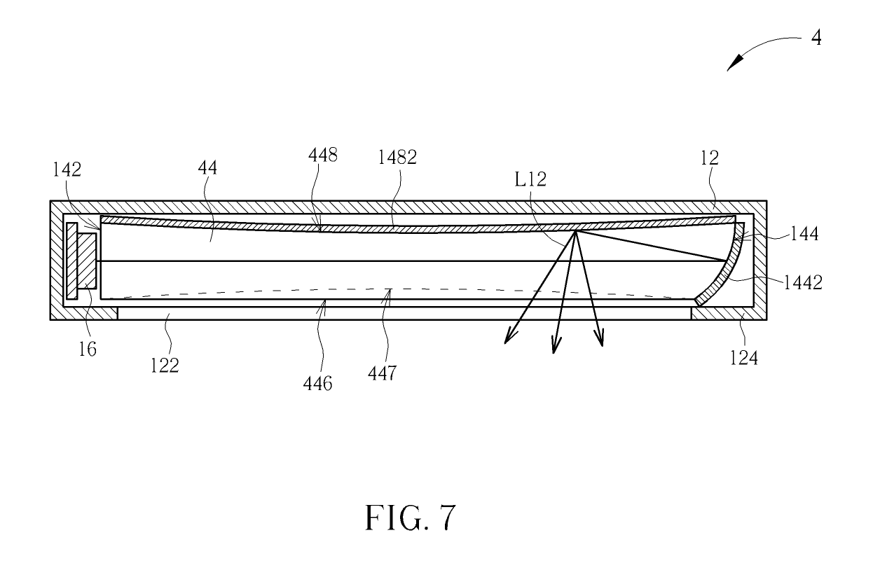

The above embodiments are based that the second surface 148 and the light emitting surface 146 are parallel to each other, but the invention is not limited thereto. Please refer to FIG. 7, which is a sectional view of a plane illumination apparatus 4 according to another embodiment. The plane illumination apparatus 4 is structurally similar to the plane illumination apparatus 1, so the plane illumination apparatus 4 still uses the component notations of the plane illumination apparatus 1. The relevant descriptions of the plane illumination apparatus 1 being applicable to the plane illumination apparatus 4 will not be described repeatedly herein. The main difference between the plane illumination apparatus 4 and the plane illumination apparatus 1 is that the second surface 448 of the light-guiding plate 44 of the plane illumination apparatus 4 is a concave surface, so that the light beam L10 in the light-guiding plate 44 can perform divergent effect so as to increase the light emitting efficiency of the light-guiding plate 44. In addition, in the embodiment, the light emitting surface 446 can be replaced with a concave surface 447, as shown by dashed lines in FIG. 7. Thereby, the light beam can be diffusely distributed to increase the illumination area. In practice, the light-guiding plate can be made with the above both structural features.

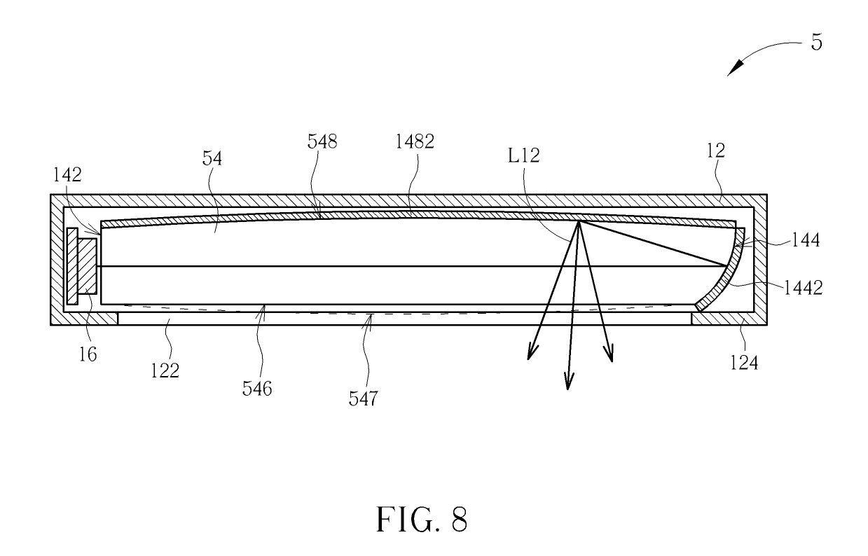

Please refer to FIG. 8, which is a sectional view of a plane illumination apparatus 5 according to another embodiment. The plane illumination apparatus 5 is structurally similar to the plane illumination apparatus 1, so the plane illumination apparatus 5 still uses the component notations of the plane illumination apparatus 1. The relevant descriptions of the plane illumination apparatus 1 being applicable to the plane illumination apparatus 5 will not be described repeatedly herein. The main difference between the plane illumination apparatus 5 and the plane illumination apparatus 1 is that the second surface 548 of the light-guiding plate 54 of the plane illumination apparatus 5 is a convex surface, so that the light beam L10 in the light-guiding plate 54 can perform convergent effect so as to increase the illuminance of the central portion of the illumination area. In addition, in the embodiment, the light emitting surface 546 can be replaced with a convex surface 547, as shown by dashed lines in FIG. 8. Thereby, the light beam can be converged slightly, which is also conducive to increasing the illuminance of the central portion of the illumination area. In practice, the light-guiding plate can be made with the above both structural features.

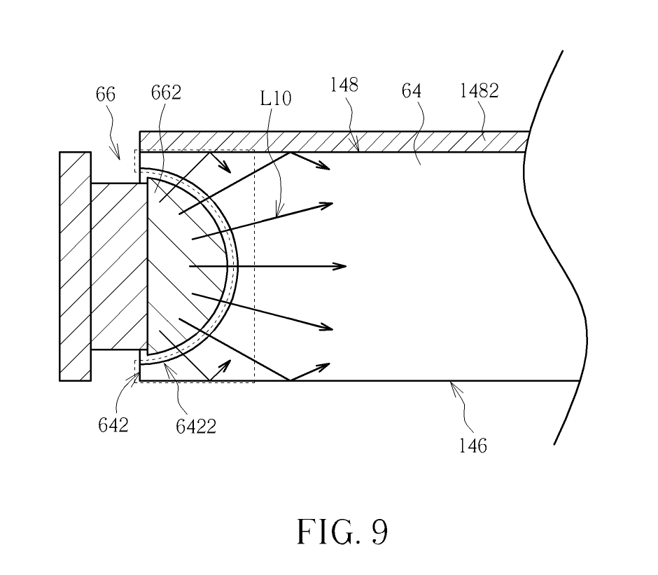

Take FIG. 2 as an example. In practice, the structures of the light-emitting source 16 and the light incident surface 142 can be designed for making the light beam L10 emitted by the light-emitting source 16 enter the light-guiding plate 14 efficiently and make the light beam L10 in the light-guiding plate 14 be transmitted uniformly in the light-guiding plate 14, such that the light beam L10 can emit out the light-guiding plate 14 from the light emitting surface 146 uniformly, which is conducive to the illumination uniformity of the illumination area. Please refer to FIG. 9, which is a sectional diagram illustrating the configuration of the light-guiding plate 64 and the light-emitting source 66 according to another embodiment. The light-guiding plate 64 is structurally similar to the light-guiding plate 14, so the light-guiding plate 64 still uses the component notations of the light-guiding plate 14. The relevant descriptions of the light-guiding plate 14 being applicable to the light-guiding plate 64 will not be described repeatedly herein. In the embodiment, the light-emitting source 66 has an optical lens 662 for distributing the light beam L10. The light incident surface 642 of the light-guiding plate 64 has a recess 6422 corresponding to the shape of the optical lens 662 for accommodating the light-emitting source 66. For example, the optical lens 662 is a semi-sphere, and the recess 6422 is a semi-spherical cavity; however, the invention is not limited thereto. Thereby, after emitting out of the optical lens 662, the light beam L10 can be received by the recess 6422 so as to mostly enter the light-guiding plate 64 to increase the usage efficiency of the light beam L10 and also to increase the light emitting efficiency of the plane illumination apparatus. It is added that in practice, a plurality of the light-emitting sources 66 are used generally, so the light-guiding plate 64 also has a plurality of recesses 6422 corresponding to the light-emitting sources 66.

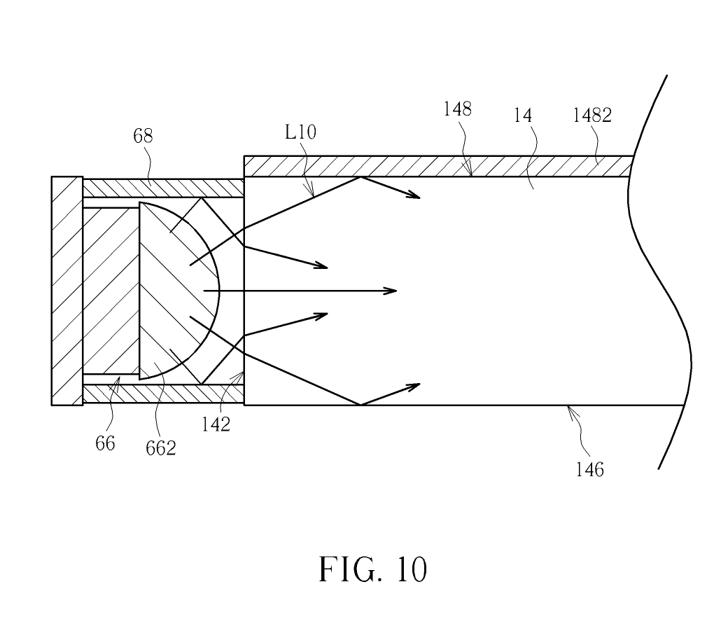

It is added that in the embodiment, the light beam L10 from the air enters into the light-guiding plate 64 with different medium leading to an occurrence of refraction at the light incident surface 642, so in logical, the portion (indicated by a rectangle in dashed line) of the light-guiding plate 64 at the light incident surface 642 can be regarded as a refraction portion. In practice, the surface (such as the surface of the recess 6422) can form a refraction profile, such that after refracted, the light beam L10 can travel toward a required direction, for uniformly emitting toward the second surface 148 for example. By the diffuse reflection effect by the second diffuse reflection layer 1482, after reflected by the second surface 148, the light beam L10 can uniformly pass through the light emitting surface 146 out of the light-guiding plate 64, so as to uniformly illuminate the illumination area. Similarly, by the refraction effect, the light beam L10 also can be deflected toward the middle portion of the second surface 148, so that after emitting out the light-guiding plate 64, the light beam L10 can mostly illuminate the central portion of the illumination area, for satisfying common requirements. In addition, in practice, if the light-guiding plate does not has the above recess 6422, such as the light-guiding plate 14, a reflection part 68 can be disposed at the outer periphery of the light-emitting source 66, such as a cylinder reflector sleeved on the light-emitting source 66, for reflecting a part of the light beam L10. The opening of the reflection part 68 contacts the light incident surface 142 with a plane surface, so that the light beam L10 emitted by the light-emitting source 66 can mostly enter the light-guiding plate 14 through the light incident surface 142, as shown in FIG. 10. Such structural configuration also can perform the effect of the above recess 6422, that is to increases the usage efficiency of the light beam L10 and the whole light emitting efficiency of the plane illumination apparatus.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-guiding plate, applied to an illumination apparatus comprising the light-guiding plate and at least one light-emitting source providing a light beam, the light-guiding plate comprising:
a light incident surface;
a first surface opposite to the light incident surface;
a second surface located between the light incident surface and the first surface and coated with a second diffuse reflection layer; and
a light emitting surface opposite to the second surface;
wherein the first surface has a first side close to the second surface, and a second side close to the light emitting surface;
the first surface extends substantially toward the light incident surface from the first side to the second side;
wherein a first portion of the light beam is diffusely reflected by the second surface and then passes through the light emitting surface out of the light-guiding plate.

2. The light-guiding plate of claim 1, further satisfying the following condition:
0<W/D<0.6;
wherein W is a width of a projection area of the first surface onto the second surface, and D is a projection distance of the second side of the first surface to the second surface.

3. The light-guiding plate of claim 2, wherein the first surface is coated with a first diffuse reflection layer, and a second portion of the light beam entering the light-guiding plate through the light incident surface is diffusely reflected by the first surface and the second surface in order and then passes through the light emitting surface out of the light-guiding plate.

4. The light-guiding plate of claim 3, wherein the light-emitting source has an optical axis, and a tangent value of an included angle between a traveling direction of the second portion of the light beam and a direction of the optical axis is smaller than a half of the projection distance of the second side of the first surface onto the second surface divided by a minimum distance between the light incident surface and the first surface.

5. The light-guiding plate of claim 1, wherein the first surface is a curved surface.

6. The light-guiding plate of claim 5, the light-emitting source having an optical axis, wherein an included angle between a normal direction of the curved surface and a direction of the optical axis monotonously increases from the first side to the second side of the first surface.

7. The light-guiding plate of claim 1, wherein the first surface comprises a plurality of successive inclined planes.

8. The light-guiding plate of claim 7, the light-emitting source having an optical axis, wherein included angles between normal directions of the inclined planes and a direction of the optical axis respectively monotonously increase from the first side to the second side of the first surface.

9. The light-guiding plate of claim 1, wherein the first surface is an inclined plane.

10. The light-guiding plate of claim 1, wherein the second surface is a concave surface or a convex surface.

11. The light-guiding plate of claim 1, wherein the light emitting surface is a convex surface or a concave surface.

12. The light-guiding plate of claim 1, wherein the light incident surface has at least one refraction portion.

13. A plane illumination apparatus, comprising:
a light-guiding plate, comprising:
a light incident surface;
a first surface opposite to the light incident surface;
a second surface located between the light incident surface and the first surface and coated with a second diffuse reflection layer; and
a light emitting surface opposite to the second surface;
wherein the first surface has a first side close to the second surface, and a second side close to the light emitting surface; the first surface extends substantially toward the light incident surface from a first side to the second side; and
at least one light-emitting source disposed corresponding to the light incident surface and providing a light beam, the light beam entering the light-guiding plate through the light incident surface, each light-emitting source having an optical axis;
wherein a first portion of the light beam is diffusely reflected by the second surface and then passes through the light emitting surface out of the light-guiding plate.

14. The plane illumination apparatus of claim 13, further comprising a casing accommodating the light-guiding plate and the at least one light-emitting source, wherein the casing has a light emitting window, and the light emitting surface is disposed opposite to the light emitting window.

15. The plane illumination apparatus of claim 13, wherein the light-guiding plate further satisfies the following condition:
0<W/D<0.6;
Wherein W is a width of a projection area of the first surface onto the second surface, and D is a projection distance of the second side of the first surface to the second surface.

16. The plane illumination apparatus of claim 15, wherein the first surface of the light-guiding plate is coated with a first diffuse reflection layer, and a second portion of the light beam entering the light-guiding plate through the light incident surface is diffusely reflected by the first surface and the second surface in order and then passes through the light emitting surface out of the light-guiding plate.

17. The plane illumination apparatus of claim 16, wherein a tangent value of an included angle between a traveling direction of the second portion of the light beam and a direction of the optical axis is smaller than a half of the projection distance of the second side of the first surface onto the second surface divided by a minimum distance between the light incident surface and the first surface.

18. The plane illumination apparatus of claim 13, wherein the first surface is a curved surface, and an included angle between a normal direction of the curved surface and a direction of the optical axis monotonously increases from the first side to the second side of the first surface.

19. The plane illumination apparatus of claim 13, wherein the first surface comprises a plurality of successive inclined planes, and included angles between normal directions of the inclined planes and a direction of the optical axis monotonously increase from the first side to the second side of the first surface.

20. The plane illumination apparatus of claim 13, wherein each light-emitting source has an optical lens for distributing the light beam, and a reflection part is disposed at an outer periphery of the light-emitting source.

21. The plane illumination apparatus of claim 13, wherein each light-emitting source has an optical lens for distributing the light beam, and the light incident surface of the light-guiding plate has at least one recess corresponding to a profile of the optical lens for accommodating the at least one light-emitting source.

22. The plane illumination apparatus of claim 13, wherein each light-emitting source has an optical lens for distributing the light beam, and the light incident surface of the light-guiding plate has at least one refraction portion corresponding to the at least one light-emitting source.
